(19) United States
(12) Patent Application Publication
(10) Pub. No.: US 2011/0174319 A1
(43) Pub. Date: Jul. 21, 2011

(54) APPARATUS FOR THE SUPPRESSION OF GRINDING AND/OR CLENCHING OF TEETH

(76) Inventor: David J. Busciglio, Lithia, FL (US)

(21) Appl. No.: 12/688,286

(22) Filed: Jan. 15, 2010

(51) Int. Cl. A61C 5/14

(52) U.S. Cl. 128/862; 128/861

(57) ABSTRACT

An occlusal device for maintaining the vertical separation of opposed teeth in the oral cavity of a patient wearing the occlusal device. The occlusal device has a trough or partial trough for containing at least some of the upper teeth or lower teeth. In the locality of the front teeth is a spacer member affixed to an outer surface opposite of the trough. In the locality of the rear teeth are forming plates removably affixed to the outer surface of the occlusal device. After taking an impression of the set of teeth within the trough, the forming plates are removed from the outer surface of the occlusal device, thereby providing gap between the wearer's rear teeth and the outer surface of the occlusal device.

### FIELD

This invention relates to the field of dental devices and more particularly to a device for reduction of teeth grinding and or clenching.

### BACKGROUND

There are many people who suffer from symptoms caused by clenching and/or grinding of their teeth during sleep. Such repetitive, unconscious jaw movements are called bruxing. Often the pain includes headaches, jaw aches, teeth aches, ear aches, etc. Often, the people suffering from these symptoms are unaware of the cause until they seek professional help. One common name for the pain resulting from such actions is called TMJ (Temporomandibular joint) disease. Left untreated, such activities by the person during sleep sometimes lead to serious bone and teeth problems. Temporomandibular joint disorder and resultant symptoms often produces significant pain and impairment. Temporomandibular joint disorder transcends the boundaries between several health-care disciplines—such as, dentistry, neurology, physical therapy, and psychology, making it difficult

Currently, the most prescribed treatment to reduce the clenching and/or grinding is to provide a mouth guard that keeps the upper teeth separated from the lower teeth by a soft material, thereby preventing grinding, but having little or no effect over clenching. Such guards cover the entire or most of the teeth.

An improvement made to this is a guard that covers only a few teeth such as only the front teeth, spacing the upper/lower front teeth at a distance from each other and, thereby, forcing a gap between the upper and lower back teeth. Such devices have had problems with falling off and choking the user. Improvements have been suggested having a string attached to such devices that leaves the wearer's mouth and goes around the wearer's neck. This reduces risk of choking, but is not comfortable during sleep.

Many such devices offer some relieve to the symptoms described above, but do not provide the comfort offered by a mouthpiece molded to conform to the wearer's teeth. Mouthpieces that are molded for the specific individual provide greater comfort because they are more stationary with respect the wearer's teeth and tend to move less within the mouth during sleep, thereby reducing skin sores and abrasions. In the past, in order to create a custom mouthpiece, impressions are taken by a dental professional and the mouthpiece is made from the impressions or similar system. Such processes take time and are expensive and require a dentist or other professional.

To combat the grinding and clenching, only one set of teeth (upper or lower) need be engaged in the mouthpiece. Also, it is preferred to provide upper/lower separation by materials inserted in between the front teeth rather than the back teeth because the front teeth are only capable of exerting only around 30% of the closing force of the back teeth due to bone/muscle leverage about the jaws. It is also preferred, though not required, that the device be customized to the wearer by the wearer; not requiring a professional such as a dentist.

What is needed is a simple system that will provide a custom mouthpiece for the reduction of pain and other problems caused by excessive grinding and clenching of one's teeth.

### SUMMARY OF THE INVENTION

In one embodiment, an occlusal device for suppression of the intensity of forces of bruxism resulting from grinding and/or clenching of teeth of a person subjected to bruxism is disclosed including a body portion that has a bite portion and one or two wall portions such that at least some of the upper teeth or lower teeth of a user are held between or next to the one or two wall portions, resting upon a teeth interface surface of the base portion. Forming plates temporarily attach to an opposing outer surface of the bite portion in proximity to where the back teeth of the person interfaces to the teeth interface surface and a spacer plate is affixed to the outer surface of the base portion in proximity to where the front teeth of the person interfaces to the teeth interface surface. After an impression is made of the teeth, the forming plates are removed from the outer surface of the base portion and a gap results between the back teeth of the person and the outer surface of the base portion, thereby reducing intensity of forces of clenching.

In another embodiment, a method of reducing the intensity of forces of bruxism resulting from grinding and/or clenching of teeth of a person subjected to bruxism is disclosed including providing an occlusal device having a base, the base having an upper portion that at least partially encloses at least some of the wearer's teeth. A spacer plate is affixed to an outer surface of the base in proximity of where the person's front teeth fit within the upper portion. Forming plates are removably affixed to an outer surface of the base in proximity of where the person's rear teeth fit within the upper portion. The method continues with preparing the occlusal device (e.g. heating or covering with impression material) then placing the occlusal device into the person's mouth. An impression is made when the person's upper teeth apply pressure to the teeth interface surface through the base, the spacer plate and the forming plates to the person's bottom teeth (or lower teeth to the upper teeth). Next, the occlusal device is removed from the person's mouth and the forming plates are removed from the outer surface of the base. The occlusal device is replaced into the person's mouth when needed to reduce the intensity of forces of clenching.

In another embodiment, an occlusal device is disclosed. The occlusal device is for suppressing of the intensity of forces of bruxism resulting from grinding and/or clenching of teeth of a person subjected to bruxism. The occlusal device includes an area or base portion for capturing a set of teeth of the person (upper or lower set). The base portion has a surface for interfacing with either an upper set of teeth and an opposing outer surface. Members for forming an impression is temporarily affixed to the outer surface in the locality of where the rear teeth interface with the teeth interface surface. A member for spacing is affixed to the outer surface in the locality of where the front teeth interface with the teeth interface surface. After the member for forming is removed from the outer surface of the base portion; a gap results between the bottom back teeth and the outer surface of the base portion, thereby reducing contact between the back teeth and reducing intensity of forces of clenching.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a front perspective view of a mouthpiece with removable forming plates.

FIG. 2 illustrates a top view of the mouthpiece.

FIG. 3 illustrates a bottom view of the mouthpiece with removable forming plates.

FIG. 4 illustrates a cut-away view along lines 4-4 of the mouthpiece with removable forming plates.

FIG. 5 illustrates a cut-away view along lines 5-5 of the mouthpiece with removable forming plates showing spacer plates.

FIG. 6 illustrates a cut-away view along lines 4-4 of the mouthpiece with removable forming plates showing optional impression material.

FIG. 6A illustrates a cut-away view along lines 4-4 of the mouthpiece with removable forming plates showing alternate impression material.

FIG. 7 illustrates a top view of the mouthpiece with removable forming plates showing impressions left in the mouthpiece material.

### DETAILED DESCRIPTION

Reference will now be made in detail to the presently preferred embodiments, examples of which are illustrated in the accompanying drawings. Throughout the following detailed description, the same reference numerals refer to the same elements in all figures. Throughout this description, upper teeth refer to the upper teeth currently possessed by the patient/user. Likewise, lower teeth refer to the set of lower teeth currently possessed by the patient/user. Front teeth generally include the incisors and optionally the eye teeth while back teeth generally include one or more of the bicuspids and molars. It is not critical as to which set of teeth are in the front set and which set of teeth are in the rear set or how many teeth are in each set as long as the front set includes at least one of the incisors and the rear set includes at least some of the molars or bicuspids.

Although shown in all figures as facing upward as to interface with the upper teeth, it is anticipated that the occlusal device as describe be interfaced to the lower teeth instead of the upper teeth. It is preferred, though not required, that the upper teeth are interfaced with the occlusal device to reduce interference with the wearer's tongue.

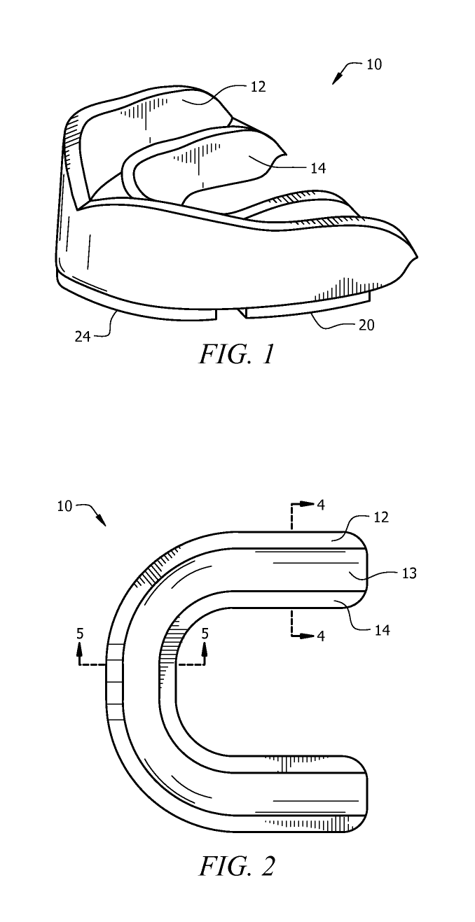

Referring to FIG. 1, a front perspective view of an occlusal device (mouthpiece) 10 with removable forming plates 20/22 is shown. It is desired to suppress the intensity of forces of bruxism by reducing grinding and clenching of the wearer's teeth. To do such, the occlusal device (mouthpiece) 10 reduces or prevents direct contact between the upper and lower teeth and provides separation of the rear upper teeth from the rear lower teeth to reduce clenching force that often affects the Temporomandibular joint. It is also desired to provide a trough or partial trough 12/13/14 that conforms to the user's teeth to improve comfort and reduce movement of the occlusal device (mouthpiece) 10 when in use, usually during sleep. Is should be noted that, although a trough 12/13/14 is preferred, in some embodiments, the inner wall 14 and/or outer wall 12 is eliminated or shortened to any height.

Prior mouthpieces provided a cushion of rubber or plastic material between the upper rear teeth and lower rear teeth. This material does not prevent a clenching force to be asserted between the upper rear teeth and lower rear teeth. It is known that the upper rear teeth and lower rear teeth are capable of a greater force than the front teeth. To improve upon this, the occlusal device (mouthpiece) 10 maintains the upper front teeth at a distance from the lower front teeth (e.g. incisors), thereby keeping the upper rear teeth from contacting the lower rear teeth, and therefore, reducing force against the temporomandibular joint (TMJ). This keeps the jaw closing muscles from fully contracting. Less force is exerted due to the fact that the rear teeth (e.g. molars) which are capable of exerting a greater amount of force than the front teeth (e.g. incisors) are spaced apart. It is estimated that the front teeth are capable of exerting only around 30% of the clenching force compared to the capabilities of the rear teeth.

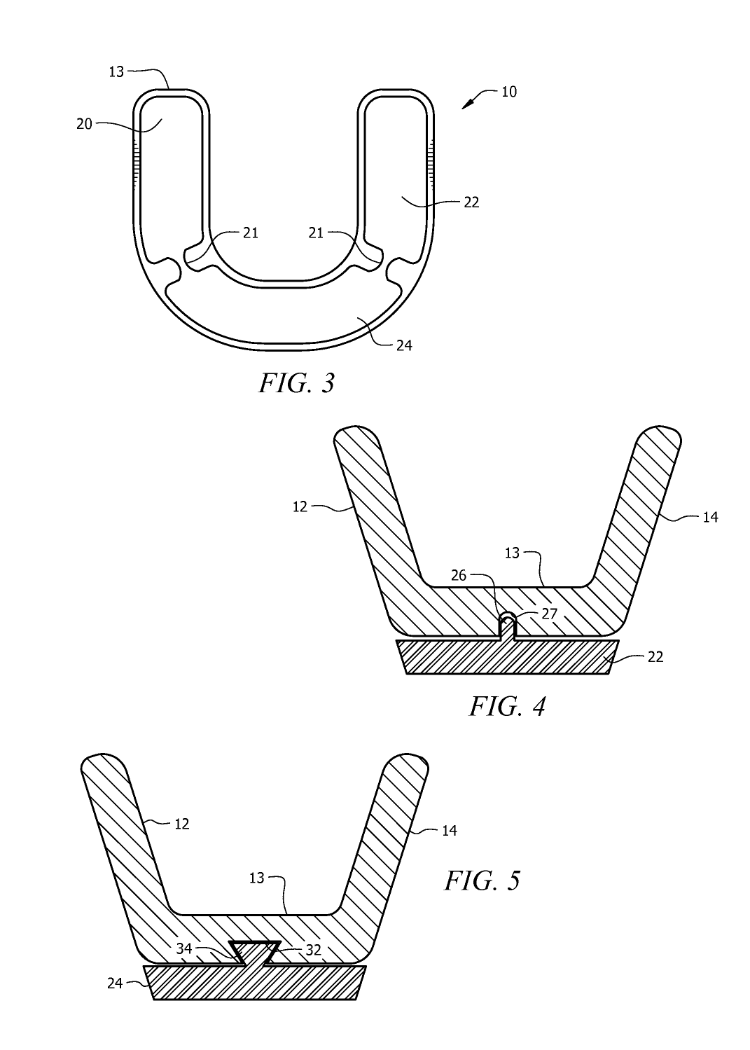

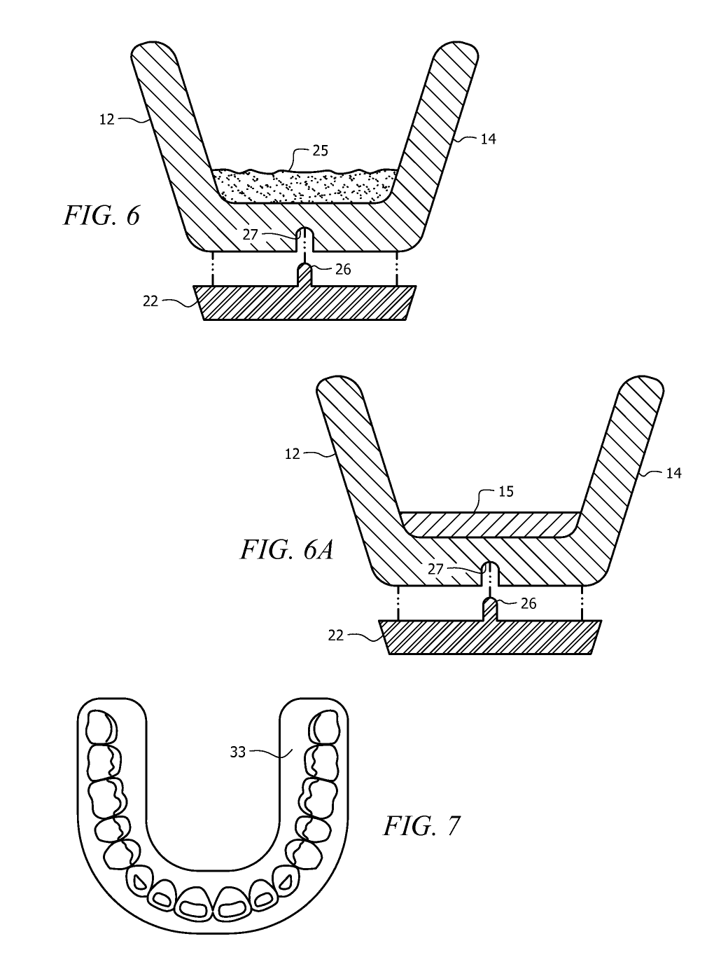

In the preferred embodiment, the occlusal device (mouthpiece) 10 conforms to a wearer's teeth by way of an impression is made on/on the surface of the bite portion 13 of the mouthpiece 10 either by heating the mouthpiece or by applying an impression material 25 (see FIG. 6) onto the surface of the bite portion 13. In the heating method, heating softens the thermal material of which the mouthpiece bite portion 13 is comprised or of which the mouthpiece bite layer 15 (see FIG. 6A) is comprised. Next, the mouthpiece 10 is placed in the wearer's mouth and the wearer's, for example, upper, teeth contact with the bite surface 13 or bite layer 15, which has been heated or covered with impression material 25. Next, pressure is applied by the wearer by closing their teeth until the bite surface/walls 12/13/14 cool, the bite layer 15 cools or until the thermal impression material 15/25 hardens thereby maintaining the form of the wearer's teeth. To permit such pressure to be applied, forming plates 20/22 (see also FIG. 3) are removably attached to an outer surface of the bite portion 13 so that, after the impression is made, the forming plates 20/22 are removed by the user. The forming plates 20/22 are removed to reduce contact between the wearer's upper and lower rear teeth (e.g., posterior teeth), especially during sleep, thereby reducing the forces of clenching. Once the forming plates 20/22 are removed, the front teeth (e.g., anterior teeth) are held apart by the spacing plate 24, thereby preventing the rear teeth (which have greater leverage/force) from contacting each other.

The mouthpiece body 12/13/14 is made of a material such as rubber or plastic. Such material is comfortable to wear in one's mouth and remains stationary in the mouth. The mouthpiece body 12/13/14 is, in some embodiments, made from a stiff, resilient material. In embodiments having an outer wall 12; the outer wall 12 positions between the user's teeth (upper or lower) and the user's lips/cheeks. For thermal impressions, at least the bite portion 13 of the mouthpiece body 12/13/14 or the bite layer 15 (see FIG. 6A) is made from a thermal impression material, preferably rubber or plastic material that changes shape under pressure when heated and retains the new shape after cooling. It is preferred that the thermal impression material be moldable at a temperature above, for example, 100 degrees Fahrenheit, and harden at a lower temperature such as below 100 degrees Fahrenheit. In such, the thermal impression material softens in, for example, boiling water or a microwave oven and hardens when cooled to body temperature (e.g. 98.6 degrees Fahrenheit) in the user's mouth thereby creating an impression. In one embodiment, the thermal impression material remains soft at a temperature of around 110-115 degrees Fahrenheit and the mouthpiece 10 is heated to this temperature before being placed in the mouth.

The removable forming plates 20/22 and the spacing plate 24 are preferably made of a stiff plastic or rubber material that does not significantly deform under pressure when the wearer applies force between his/her upper teeth and lower teeth. One exemplary forming plate 20/22 and spacing plate 24 material is acrylic plastic. In some embodiments, the spacing plate 24 is formed as an extension of the bite portion 13 while in the preferred embodiment, the spacing plate 24 is made of a different, harder material than the bite portion 13.

Any suitable materials are anticipated as known in the art of mouthpieces and dentistry.

Referring to FIG. 2, a top view of the mouthpiece 10 with removable forming plates 20/22 is shown. In this view, the body trough formed by the walls 12/14 and bite portion 13 is shown. The removable forming plates 20/22 and space 24 are not visible. It is anticipated that the walls 12/14 and bite portion 13 are made/molded as one part or separate parts, as known in the industry. The bite portion 13 has a teeth interface surface and an opposing outer surface.

Referring to FIGS. 3, a bottom view of the mouthpiece 10 with removable forming plates 20/22 is shown. The removable forming plates 20/22 are removably attached to the outer surface of the bite portion 13 of the mouthpiece 10 in location of where the rear teeth rest and the spacing plate 24 is attached to the outer surface of the bite portion 13 in the location of where the front teeth rest. It is anticipated that in some embodiments, the removable forming plates 20/22 and the spacing plate 24 are made of a continuous material with break-off points 21. In other embodiments, the removable forming plates 20/22 and the spacing plate 24 are made of distinct components, not bridged to each other. In embodiments in which the removable forming plates 20/22 are bridged to the spacing plate 24 by a bridge connection 21, when the removable forming plates 20/22 are removed from the spacing plate 24, the bridge connection 21 is broken by, for example, bending or twisting.

The removable forming plates 20/22 are attached to the outer surface of the bite portion 13 in such a way as to provide removal from the outer surface of the bite portion 13 by the typical user while the spacing plate 24 remains attached to the outer surface. The spacing plate 24 is attached by more permanent structures/materials to reduce the chance that the user will detach the spacing plate 24 from the outer surface of the bite portion 13.

In the example of FIGS. 4, 6 and 6A, a preferred way of affixing removable forming plates 20/22 to the outer surface of the bite portion 13 is shown. In such, the forming plates 20/22 have protrusions 26 that fit snuggly in receptacles 27 of the outer surface of the bite portion 13. The snug fit holds the protrusions 26 that fit snuggly in receptacles 27 by way of friction and/or suction. Any other shape of protrusions 26 and receptacle 27 is anticipated including rounded, square, etc. Other methods of attaching the removable forming plates 20/22 to the outer surface of the bite portion 13 are anticipated including fasteners, temporary adhesives, gum material, etc.

Likewise, a preferred way of attaching the spacing plate 24 to the outer surface of the bite portion 13 is shown in FIG. 5. In this, the spacing plate 24 has one or more keystone-shaped domes 34 that fit within similar-shaped receptacles 32. During manufacture, the domes 34 are pushed into the receptacles 32 and deform to fit, and then expand once inside, making it difficult to remove the domes 34 from the receptacles 32. Any other shape of dome 34 and receptacle 32 is anticipated including rounded, etc. Other methods of attaching the spacing plate 24 to the outer surface of the bite portion 13 are anticipated including fasteners, ultrasonic welding, adhesives, etc. In some embodiments, the spacing plate 24 is made as part of the mouthpiece body 12/13/14 as one solid piece.

Referring again to FIG. 6, the mouthpiece 10 with removable forming plates 20/22 having optional impression material 25 installed is shown. In this view, the protrusions 26 of the removable forming plates 20/22 interfaces with the receptacles 27. In this example, the optional impression material 25 is spread upon the teeth interface surface of the bite portion 13 and is ready to accept, for example, the user's upper teeth. Some examples of impression material are waxes, polysulfide polymer, polymerizing/addition reaction silicones such as polyvinyl siloxanes or vinylpolysiloxanes, condensation curing silicones such as polysilixone, polysulfide (mercaptan thiokol rubber), reversible hydrocolloids (agar), irreversible hydrocolloids (alginate) and polyether. In some embodiments, it is preferred to include features on the base of the bite portion 13 and/or walls 12/14 for holding the impression material 25 after hardening (not shown) as known in the industry.

Referring again to FIG. 6A, the mouthpiece 10 with removable forming plates 20/22 having the bite layer 15 is shown. In this view, the protrusions 26 of the removable forming plates 20/22 interfaces with the receptacles 27 as in

FIG. 6. Instead of fabricating the mouthpiece body 12/13/14 from a thermal impression material, the mouthpiece body 12/13/14 is made from a plastic or rubber material that does not deform (significantly) when heated and, in this example, a bite layer 15 made of thermal impression material is affixed or bonded to the teeth interface surface of the bite portion 13. The bite layer 15 interfaces with, for example, the user's upper teeth. When the mouthpiece 10 is heated, the bite layer 15 softens and deforms under pressure from the user's teeth, forming impressions 33 (see FIG. 7). The user maintains the pressure until the bite layer 15 cools enough to harden, thereby retaining the impressions 33.

Referring to FIG. 7, a top view of the mouthpiece 10 with removable forming plates 20/22 showing impressions 33 left in the mouthpiece material is shown. After heating the mouthpiece 10, biting down and allowing the mouthpiece 10 to cool while biting down, the teeth interfacing surface of the bite portion 13 or the bite layer 15 will retain impressions 33 of the user's teeth. Likewise, after placing impression material 25 over the teeth interfacing surface of the bite portion 13 of the mouthpiece 10, biting down and allowing the impression material 25 to harden while biting down, the impression material 25 will likewise retain impressions 33 of the user's teeth. The impression 33 will hold better to the user's teeth and reduce movement of the mouthpiece 10, thereby improving comfort, especially during sleep.

Equivalent elements can be substituted for the ones set forth above such that they perform in substantially the same manner in substantially the same way for achieving substantially the same result.

It is believed that the system and method and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An occlusal device for suppression of the intensity of forces of bruxism resulting from grinding and/or clenching of teeth of a person subjected to bruxism, the teeth comprising an upper set of teeth and a lower set of teeth, the device comprising:
a body portion having a bite portion and at least one wall portions, the bite portion having a teeth interface surface and an opposing outer surface, whereas at least some of either the upper set of teeth or the lower set of teeth rest upon the teeth interface surface;
forming plates temporarily attached to the outer surface, the forming plates located in proximity to back teeth of the teeth; and
a spacer plate affixed to the outer surface, the spacer plate located in proximity to front teeth of the teeth;
whereas, the after the forming plates are removed from the outer surface, a gap results between the back teeth and the outer surface, thereby reducing intensity of forces of clenching.

2. The occlusal device of claim 1, wherein the bite portion is made of a thermal impression material that conforms to a user's teeth when heated above 100 degrees Fahrenheit and hardens after accepting an impression of the user's teeth when cooled below 100 degrees Fahrenheit.

3. The occlusal device of claim 1, further comprising an impression material deposited on the teeth interface surface of the bite portion, the impression material conforming to the teeth when exposed to the teeth, the impression material hardening around the teeth, thereby maintaining an impression in the shape of the teeth.

4. The occlusal device of claim 1, wherein the forming plates temporarily attach to the spacer plate by bridges.

5. The occlusal device of claim 1, wherein the forming plates temporarily attach to the outer surface of the bite portion by one or more protrusions on the forming plates that mate with receptacles in the outer surface of the bite portion.

6. The occlusal device of claim 1, wherein the spacing plate attaches to the outer surface of the bite portion by one or more keys on the spacing plate that mate with key holes in the outer surface of the bite portion.

7. The occlusal device of claim 1, wherein the spacing plate attaches to the outer surface of the bite portion by an adhesive.

8. The occlusal device of claim 1, wherein the spacing plate is formed as part of the outer surface of the bite portion.

9. A method of reducing the intensity of forces of bruxism resulting from grinding and/or clenching of teeth of a person subjected to bruxism, the method comprising:
providing an occlusal device having a base, the base having a trough portion that at least partially encloses either upper teeth of the teeth or lower teeth of the teeth, the trough portion having a teeth interface surface and an opposing outer surface, the base having a spacer plate affixed to the outer surface in proximity of where front teeth of the teeth fit within the trough portion and the base having forming plates removably affixed to the outer surface in proximity of where rear teeth of the teeth fit within the trough portion;
preparing the teeth interface surface;
placing the occlusal device into the person's mouth;
forming an impression of the teeth interfaced with the teeth interface surface by applying pressure between the person's upper set of the teeth and the person's lower set of the teeth, the base, the spacer plate and the forming plates;
removing the occlusal device from the person's mouth;
removing the forming plates from the outer surface of the base; and
re-placing the occlusal device into the person's mouth to reduce intensity of forces of clenching.

10. The method of claim 9, whereas the teeth interface surface is made of a thermal impression material and wherein the step of preparing includes heating the teeth interface surface.

11. The method of claim 9, whereas the teeth interface surface is covered with a layer of a thermal impression material and wherein the step of preparing includes heating the teeth interface surface.

12. The method of claim 9, wherein the step of preparing includes applying dental impression material to the teeth interface surface.

13. The method of claim 9, wherein the forming plates removably attach to the outer surface of the base portion by protrusions on the forming plates that mate with receptacles in the outer surface of the base portion.

14. The method of claim 9, wherein the spacing plate attaches to the outer surface of the base portion by a key on the spacing plate that mates with a key hole in the outer surface of the base portion.

15. An occlusal device for suppression of the intensity of forces of bruxism resulting from grinding and/or clenching of teeth of a person subjected to bruxism, the teeth having an upper set of teeth and a lower set of teeth, the device comprising:
a means for holding the upper set of teeth, the means for holding comprising at least a base portion, the base portion having a teeth interface surface and an opposing outer surface;
a means for forming an impression of the set of teeth in the means for holding, the means for forming the impression temporarily attached to the outer surface of the base portion in a locality of back teeth of the set of teeth; and
a means for spacing affixed to the outer surface of the base portion, the means for spacing attached to the outer surface of the base portion in a locality of front teeth of the set of teeth;
whereas, after the means for forming is removed from the outer surface of the base portion, a gap results between back teeth of the lower set of teeth and the outer surface of the base portion, thereby reducing intensity of forces of clenching.

16. The occlusal device of claim 15, wherein the base portion is made of a thermal impression material that conforms to the upper set of teeth when heated above 100 degrees Fahrenheit and hardens after accepting an impression of the upper set of teeth when cooled below 100 degrees Fahrenheit.

17. The occlusal device of claim 15, further comprising an impression material deposited on the teeth interface surface, the impression material conforming to the upper set of teeth when the occlusal device is inserted into a mouth of the person and the upper set of teeth is forced into the impression material, the impression material hardening around the upper set of teeth, maintaining the shape of the upper set of teeth.

18. The occlusal device of claim 15, wherein the means for forming includes forming plates temporarily attached to the outer surface of the base portion by one or more protrusions on the forming plates that mate with receptacles in the outer surface of the base portion.

19. The occlusal device of claim 15, wherein the means for spacing is a spacing plate attached to the outer surface of the base portion by one or more keys on the spacing plate that mate with key holes in the outer surface of the base portion.

20. The occlusal device of claim 15, wherein the means for forming includes forming plates temporarily attached to the outer surface of the base portion by a temporary adhesive.
